(19) United States
(12) Patent Application Publication
(10) Pub. No.: US 2006/0173154 A1
(43) Pub. Date: Aug. 3, 2006

(54) Process for making low color poly(ethylene-co-isosorbide) terephthalate polymer

(76) Inventor: Larry F. Charbonneau, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/227,800

(22) Filed: Sep. 14, 2005

Related U.S. Application Data
(60) Provisional application No. 60/609,900, filed on Sep. 14, 2004.

(51) Int. Cl. C08G 63/02

(52) U.S. Cl. 528/272

(57) ABSTRACT

Described herein are processes for making poly(ethylene-co-isosorbide)terephthalate polymers in the presence of a primary and a secondary antioxidant to produce a polymer of low color. The copolymers are useful for making bottles, hot-fill containers, films, sheets, fibers, strands and optical articles, and in forming blends and alloys.

### FIELD OF THE INVENTION

The present invention is directed to processes for making poly(ethylene-co-isosorbide) terephthalate polymers in the presence of a primary and a secondary antioxidant to produce polymers of low color.

### TECHNICAL BACKGROUND

The diol 1,4:3,6-dianhydro-D-sorbitol, referred to herein as isosorbide, is readily made from renewable resources, such as sugars and starches. For example, isosorbide can be made from D-glucose by hydrogenation followed by acid-catalyzed dehydration.

Poly(ethylene-co-isosorbide) terephthalate polymer (PEIT) is a polymer with a higher glass transition temperature (Tg) than polyethylene terephthalate (PET). This positions it for use in products such as bottles, hot-fill containers, film, thick sheet, fibers, strand and optical articles. In many of these markets, aesthetics are important, and having a very low color resin is highly desirable.

Antioxidant mechanisms and typical antioxidant additives are disclosed in “Plastics Additives Handbook”, H. Zweifel, ed., Hanser Publishers, Munich, 2001, pp. 10-15, which discloses that hydroperoxide decomposers are usually used in combination with H-donors, e.g., phenols. Typical hydroperoxide decomposers include organic compounds of trivalent phosphorus such as phosphites and phosphonites.

U.S. Pat. No. 5,874,517 discloses a process for reducing the amount of acetaldehyde generated when PET chip is subjected to high temperatures, and has as a stated objective to provide a PET resin retaining color values that mimic clear glass. The process comprises the addition of antioxidants either prior to or after the PET condensation reaction.

PEIT contains isosorbide, which leads to greater sensitivity of the polymer to oxidation and to undesired color formation. U.S. Pat. No. 6,656,577 discloses a process for making poly(ethylene-co-isosorbide) terephthalate polymer that has low color and low diethylene glycol content. The disclosed process includes carrying out the polymerization reaction in an inert atmosphere at a temperature in the range 180-255 degrees C and a pressure in the range of 0-60 psig, with concurrent removal of a distillate. The distillate contains less than about 5 wt % ethylene glycol and less than about 1 wt % isosorbide.

A need remains PEIT polymers having reduced color, and for new processes for producing such polymers. The present invention is directed to these and other important ends.

### SUMMARY

One aspect of the present invention is a melt polymerization process for the preparation of poly(ethylene-co-isosorbide) terephthalate (PEIT), comprising:
a) heating a mixture comprising terephthalic acid or its alkyl ester, ethylene glycol, isosorbide and a primary antioxidant in an inert atmosphere at a temperature of 180° C.-265° C. and a pressure of 0-60 psig, with concurrent removal of a distillate comprising water or volatile alkanol products derived from the reaction of terephthalic acid or its ester with ethylene glycol and isosorbide, wherein the molar ratio of diols to terephthalic acid or its alkyl ester is from about 1.05:1 to about 2.2:1, the molar ratio of ethylene glycol to isosorbide is from about 1.2:1 to about 24:1, and the amount of primary antioxidant is 50 to 1500 ppm by weight of the terephthalic acid or terephthalic alkyl ester charged and the distillate contains less than about 1 wt % ethylene glycol; and
b) further heating the mixture in the presence of a polycondensation catalyst and a secondary antioxidant, wherein the secondary antioxidant is 50 to 3000 ppm by weight of the terephthalic acid or terephthalic ester charged, at a pressure of about 0.25 to about 2 mm and a temperature of 260° C. to 275° C. to form a PEIT having a Hunter b* color value between about −2.0 and about +2.0.

Another embodiment of the invention is low color PEIT polymers made by this process, wherein the PEIT polymers have a Hunter b* color value between about −2.0 and about +2.0.

Another embodiment of the invention is bottles, hot-fill containers, films, thick sheet, optical articles, fibers, strand and polymer blends and alloys made from the PEIT polymer of the process described herein.

### DETAILED DESCRIPTION

One embodiment of the present invention is a process to make PEIT polymer that has low color for use in hot-fill containers, bottles, thick sheets, films, fibers, strands, optical articles and other applications. Color is commonly expressed in terms of Hunter numbers, which correspond to the lightness or darkness (“L”) of a sample, the color value (“a*”) on a red-green scale, and the color value (“b*”) on a yellow-blue scale. It is usually desired to produce polymers with “L” between 80 and 100, preferably 90 to 100. Similarly, for low color polymers, “a*” and “b*” are preferably between about −2.0 and about +2.0, more preferably between about −1.0 and about +1.0, as measured by the process described herein. It has been found that these objectives can be met for PEIT without the use of color-correcting additives by controlling critical process parameters at each stage of the polymerization process, especially temperature and pressure.

For processes directed to making low color PEIT, it is also desirable to eliminate, or at least minimize, the color-forming impurities present in the monomer diols. This can be done by careful purification of the diols prior to their use in the polymerization process and storage of the monomer diols under an inert atmosphere. Preferably, the UV light transmission of ethylene glycol at 220 nm, measured in a 1 cm quartz cell vs. a distilled water reference, has a minimum transmission of 70% (ASTM 1176-87) and preferably at least 80%. Similarly, the UV light transmission of isosorbide, measured in a 5 cm cell as a 20 wt % solution in distilled water vs. a distilled water reference at 220 nm has a transmission of at least 80%.

U.S. Pat. No. 6,063,465, the disclosures of which are incorporated herein by reference, discloses the range of isosorbide content in PEIT resins suitable for making polyester containers, processes for making such resin, and a method for making containers from that resin. Melt polymerization processes are described using either dimethyl terephthalate or terephthalic acid as the acid component.

It has been found that the use of antioxidants in the production of PEIT polymers significantly reduces the color of these polymers. Because isosorbide itself is somewhat oxidation-prone, it is desirable to add the primary antioxidant to the initial mixture of monomers and optional catalyst. Suitable primary antioxidants include hindered phenols such as:
Hostanox® 0 3 (CAS #32509-66-3)
Hostanox® 0 10 (CAS #6683-19-8)
Hostanox® 0 16 (CAS #2082-79-3)
Ultranox®210 (Tetrakis methylene (3,5-di-t-butyl-4-hydroxyhydrocinnamate)methane (CAS #6683-19-8)
Ultranox® 276 (Octadecyl 3,5-di-t-butyl-4-hydroxyhydrocinnamate (CAS #2082-79-3)
Dovernox® 10 (Tetrakis methylene (3,5-di-t-butyl-4-hydroxyhydrocinnamate)methane
Dovernox® 76 (Octadecyl 3,5-di-t-butyl-4-hydroxyhydrocinnamate
Dovernox® 3114 (1,3,5-tris(3,5-t-butyl-4-hydroxybenzyl)-3-trazine-2,4,6-(1H,3H,5H)trione
Irganox® 1010 Pentaerythritol Tetrakis (3-(3,5-di-t-butyl4-hydroxyphenyl)propionate) (CAS #6683-19-8)
Irganox® 1076 (Octadecyl 3,5-di-t-butyl-4-hydroxyhydrocinnamate (CAS #2082-79-3)

The primary antioxidant is added at 50 to 1500 ppm (by weight) based on the weight of the terephthalic acid or terephthalic ester charged.

Optimal color values are obtained when a secondary antioxidant is added to the reaction mixture prior to the polycondensation step. Suitable secondary antioxidants include trivalent phosphorus compounds such as:
Ultranox® 626 (CAS #26741-53-7)
Doverphos® S-9228 Bis(2,4-dicumylphenyl)pentaerythritol diphosphite
Sandostab® P-EPQ (CAS #153550-59-5; main component is CAS # 38613-77-3)

The secondary antioxidant is added at 50 to 3000 ppm (by weight) based on the weight of the terephthalic acid or terephthalic ester charged.

The choice of polycondensation catalyst also influences the color of the final polymer. Suitable catalysts include Sb(III) salts; Ti(IV) salts; acetate and other alkanoate salts of Co(II); acetate and other alkanoate salts of Sb(III); oxides of Sb(III); oxides of Ge(IV); and Ti(OR)₄, where R is an alkyl group having 2 to 12 carbon atoms. Glycol-solubilized oxides of these metal salts may also be used. In one embodiment of this invention, solubilized oxides of Sb(III) and Ge(IV) are used as polycondensation catalysts. In one embodiment, the amount of polycondensation catalyst is generally from about 10 to about 300 ppm by weight. In one embodiment of this invention, the molar ratio of catalyst to terephthalic acid or its ester is from about 1:1000 to about 1:7300; in another embodiment, the ratio is from 1:2200 to about 1:4400.

Incorporation of the isosorbide monomer in the polymer raises the Tg of the final PEIT polymer (relative to PET), while DEG (diethylene glycol) incorporation tends to lower the Tg. For applications in which low DEG is desired (e.g., to maximize Tg) and the polymerization process uses terephthalic acid, one can add a suitable base such as sodium acetate, sodium hydroxide or tetramethylammonium hydroxide (TMAH). An effective amount of base is about 10 to about 300 ppm, based on terephthalic acid. For applications needing high Tg values, the DEG content is preferably less than about 1.5 mol %, more preferably less than about 1.0 mol %.

The polymerization process of this invention is a condensation polymerization of ethylene glycol, isosorbide, and terephthalic acid or its alkyl ester. Suitable terephthalic acid esters for the process of this invention include mono- and di-alkyl esters of terephthalic acid, wherein the alkyl group is chosen from the group of C₁ to C₆ alkyls. In one embodiment of this invention, the terephthalic acid ester is dimethyl terephthalate. In one embodiment of the invention, the molar ratio of diols (ethylene glycol and isosorbide) to terephthalic acid (or its ester) is from about 1.05:1 to about 2.2:1, and the molar ratio of ethylene glycol to isosorbide is from about 1.2:1 to about 24:1, preferably from about 6:1 to 18:1.

The polymerization process can be carried out in either batch, semi-continuous or continuous mode. In one embodiment, the process is carried out in a reactor equipped with a distillation column and a stirrer or other means for agitation. The distillation column separates the volatile product of reaction (water and/or alkanol) from volatile reactants (e.g., ethylene glycol and isosorbide). Use of a distillation column allows for operation at a lower molar ratio of ethylene glycol to terephthalic acid, which serves to suppress the formation of DEG and to increase the incorporation of isosorbide into the polymer. When terephthalic acid is used in the polymerization process, the volatile reaction product will be water; when an ester such as dimethyl terephthalate is used, the volatile reaction product will be the corresponding alkanol (such as methanol), together with smaller amounts of water.

The reactants (terephthalic acid or its ester, ethylene glycol and isosorbide), the primary antioxidant(s) and other optional catalysts and additives are loaded into the reactor, and optionally, the reactor is purged to remove traces of oxygen. Inert gases such as nitrogen can be used for this purpose. Polymerization starts by heating the reactants in an inert atmosphere at a pressure between about 0 and about 60 psig and removing the water and/or alkanol and other volatile by-products via distillation as they are formed. The temperature is initially increased to about 220° C. when terephthalic acid is used or to about 180° C. when a terephthalic acid ester is used, and then more slowly to a final temperature of between 230° C. to 265° C. The bulk of the water and/or alkanol are removed over about a 1 to 8 hour period.

When terephthalic acid is used, at least 80%, preferably at least 90%, of the water of reaction is removed as the temperature of the reaction mixture is increased from 220° C. to a temperature between 230° C. and 265° C. Limiting the maximum reaction mixture temperature to about 265° C. minimizes the formation of color-forming by-products. In one embodiment, water removal is conducted under temperature and pressure conditions that selectively remove water and return ethylene glycol to the reactor. Preferably, the distillate contains less than about 1 wt % ethylene glycol. This can be achieved by any of at least three methods. The first method controls the distillate composition by adjusting the temperature of the reaction mixture so that the temperature of the vapor at the top of the distillation column (overhead vapor) does not exceed the boiling point of water at the reactor pressure. If the temperature of the overhead vapor exceeds the boiling point of water, then the temperature of the reaction mixture is lowered and no distillate is taken off until the overhead vapor temperature drops below the boiling point of water at the reactor pressure. A second method returns the cooled distillate from the reactor condenser to the reactor until the top of the distillate column does not exceed the boiling point of water at the reactor pressure. A third method adds ambient temperature ethylene glycol, or preferably water, to the top of the distillate column until the temperature of the vapor at the top of the distillation column does not exceed the boiling point of water at the reactor pressure.

When the temperature of the reaction mixture reaches a temperature between 230° C. and 265° C. and the overhead vapor temperature drops to about 2° C. to 20° C. below the boiling point of water or alkanol at the reactor pressure, preferably about 5° C. below the boiling point of water or alkanol at the reactor pressure, the reactor pressure is reduced to about atmospheric pressure at a rate of about 0.5-5 psi/min, preferably about 1-2 psi/min. As the reactor pressure drops, additional water and/or alkanol will distill from the reactor. The optimal rate of pressure reduction is determined by the temperature of the overhead vapor. If the overhead vapor temperature exceeds that of the boiling point of water or alkanol at the reactor pressure, the rate of pressure reduction is decreased. Conversely, if the temperature of the overhead vapor is below the temperature of the boiling point of water or alkanol at the reactor pressure, the rate of pressure reduction is increased. If the total amount of water or alkanol removed when the reactor is at atmospheric pressure is less than the desired amount, the pressure can be lowered to about 80 mm Hg (for terephthalic acid) or to about 125 mm Hg (for dimethyl terephthalate) to further drive the esterification reaction. For other terephthalic acid esters, the pressure can be lowered to that pressure at which the alkanol boils at ambient temperature. Generally, it is preferable to remove a total of at least 90% of the volatile reaction products (water and/or alkanol) before going on to the next stage of the polymerization process.

The next stage of the polymerization process is polycondensation, in which the esters and oligomers are reacted to form polymer, with removal of residual ethylene glycol, isosorbide and water and/or alkanol. If a polycondensation catalyst was not added with the monomers, it is added at this stage, together with the secondary antioxidant(s) and optionally other desired additives such as infrared absorbing agents, dyes, pigments, UV stabilizers and other thermally stable additives.

Useful color-correcting additives include red, orange, yellow, blue, green, indigo and violet dyes and pigments. Examples of such dyes and pigments which are especially useful in lowering the b* value of the PEIT polymer include cobalt acetate, HS-325 Sandoplast) Red BB (a monoazo compound, also referred to as Solvent Red 195), HS-510 Sandoplast® Blue 2B (an anthraquinone, CAS number 116-75-6), Polysynthren® Blue R (hexasodium 6,13-dichloro-3,10-bis((4-(2,5-disulfonatoanilino)-6-fluoro-1,3,5-triazin-2-ylamino)prop-3-ylamino)-5,12-dioxa-7,14-diazapentacene-4,1 1-disulfonate; CAS number 67905-17-), and Clariant® RSB violet (CAS number 81-48-1).

Color-correcting additives are typically added at the beginning of the polycondensation phase of the polymerization process. The reactor pressure is then reduced to about 0.25 mm-2 mm Hg, preferably to about 0.25 mm-1 mm Hg. The temperature of the reaction mixture is raised to 260° C.-275° C. while the pressure is lowered. The reaction mixture is held at this temperature and pressure for about 1 to 4 hours to form the desired PEIT polymer. Minimizing time at high temperatures helps to minimize color generation in the PEIT polymer.

The polymer can be removed from the reactor and isolated by any of several conventional techniques as strands, pellets or flake. An inherent viscosity (IV) of 0.5 dL/g or higher can be achieved by this melt polymerization process. The IV can be further increased by solid state polymerization of the isolated polymer.

The process of this invention produces a PEIT polymer that has low color and low DEG content and is useful in hot-fill container, bottle, fiber, optical articles, film and thick sheet applications. The PEIT of this invention can also be used in making polymer blends and alloys

### EXAMPLES

Molecular weights were determined by size exclusion chromatography (SEC). The SEC system consists of a Waters (Milford, Mass.) Alliance 2690 with the solvent vacuum degasser and auotoinjection system. A Viscotek (Houston, Tex.) T60A combination viscometer/light scattering detector is followed by a Waters 410 refractive index detector. Two Shodex (Tokyo, Japan) GPC HFIP-806M linear columns are proceeded by a corresponding precolumn. The chromatograph oven holds the columns at 35° C. The T60A detectors are at ambient temperature and the refractive index detector is held at 35° C. A 10 mg sample is weighed into a 20 ml glass vial. To the vial is added 5 ml of hexafluoroisopropanol. The sample is placed on a shaker for 1-2 hours for dissolution. If the sample requires heat to dissolve, it is placed on a dry bath (VWR, South Plainfield, N.J.) containing plastic beads. The surface temperature of the dry bath is held at 80° C. The sample never reaches the boiling point of HFIP (59° C.). The sample is filtered through a 0.5 micron PTFE filter (Millipore) prior to injection of 100 μl into the SEC unit. The data are collected and analyzed using the Viscotek TriSec 3.0 software.

DSC was used to determine Tg values. The polymer sample (10 mg) is analyzed with a TA Instruments 2920 DSC from room temperature to 280° C. using a heating rate of 10° C./min. The sample is then held at 280° C. for two minutes, quenched in liquid nitrogen, and then reheated from room temperature to 280° C. The associated software calculates a Tg, Tc, and Tm.

Isosorbide and diethylene glycol content were determined by NMR. The PEIT is prepared for analysis by hot pressing at about 260° C. and cold quenching (ice bath). About 20 mg of the resulting film is dissolved in about 1 mL trichloroethane-d2. The sample is analyzed at 100° C. using a Varian (Palo Alto, Calif.) 500 MHz spectrometer.

The color and brightness of the PEIT samples were determined on 1/8 inch amorphous pellets using a HunterLab Colorflex instrument to determine Hunter L*a*b* values. The L* coordinate indicates brightness, where 0 is black and 100 is white. The a* value can be positive or negative, where positive values are indicative of red color and negative indicate green. Similar is the b* value, where positive values indicate yellow and negative values indicate blue.

Intrinsic viscosities were measured using a Viscotek Forced Flow Viscometer model Y-900. Polymers were dissolved in 50/50 w/w trifluoroacetic acid/methylene chloride at a 0.4% (wt/vol) concentration and were tested at 19° C. The intrinsic viscosities determined by this method are equivalent to Goodyear intrinsic viscosities.

COOH end groups were determined using Fourier Transform Infrared spectroscopy on polyester samples that had been dried and pressed into film. Peak absorptions were found at 3434 cm⁻¹ with respect to a baseline drawn from 3473 to 3386 and at 3266 with respect to a baseline drawn from 3717 to 620. The ratio of the 3434 to 3266 peak absorptions was compared to a calibration chart of such ratios versus titration data to obtain the concentration of COOH end groups. OH end groups were then calculated from the COOH end groups and the DP that had been determined from the IV, using the formula

$$O H ends , \text{meq/kg} = ( \frac{2 * 106}{( 192 * DP + 33 )} ) - [ C O O H ]$$

Germanium oxide solution was supplied by Teck Cominco LTD (North Vancouver, BC, Canada). Polymer grade isosorbide (Polysorb P) was supplied by Roquette Freres in Lestrem, France. Ethylene glycol was supplied by PD Glycol (Beaumont, Tex.). Terephthalic acid was supplied by Amoco (Naperville, Ill.). Dimethyl terephthalate was supplied by KoSa (Wilmington, N.C.). Cobalt acetate tetrahydrate and tetramethyl-ammonium hydroxide were obtained from Sigma-Aldrich Co. (Milwaukee, Wis.). Sandostab® P-EPQ was purchased from Clariant Corporation (Charlotte, N.C.). Graphite was supplied by Timcal America, Inc. (Westlake, Ohio). Irganox® 1010 was obtained from Ciba Speciality Chemicals Corporation (Tarrytown, N.Y.).

The following examples are for illustrative purposes and are not limiting.

### Comparative Example 1

A 10 liter agitated vessel, equipped with a column and in-line condenser, was charged with 30 moles (4983 g) of terephthalic acid (Amoco TA-33-LP), 32.31 moles (2006.6 g) ethylene glycol, 2.19 moles (319.6 g) of isosorbide, 12.0 ml of GeO₂ solution (0.15 g Ge/ml), 0.797 ml tetramethylammonium hydroxide (25 wt % aq. solution), 0.628 g cobalt acetate tetrahydrate, and 0.089 g graphite (Timrex KS-4). After 3 nitrogen pressure/purge cycles, the unit was pressured to 35 psig and the vessel heater setpoint was adjusted to give an initial batch temperature of 250° C. After approximately 90% of the water of reaction was removed, the vessel pressure was reduced to atmospheric pressure to continue esterification for 1 h. After 50 min into the atmospheric pressure esterification, 18.83 ml of a 3% solution of phosphoric acid in ethylene glycol was added to the vessel. The vessel was heated to 265° C. while the pressure was dropped to approximately 1 mm Hg over 30 min. After polymerizing 2 h at 1 mm Hg, the agitator was stopped and the vessel pressure was raised to approximately 50 psig. The melt was extruded under nitrogen pressure through a die plate to make strands. The strands were pulled through water troughs and into a cutter to make ⅛″ pellets. The product IV was 0.49 dL/g. Polymer color as measured by a HunterLab Colorflex was: a*=−0.03, b*=2.25 and L*=55.5. When measured by differential scanning calorimetry (DSC) at a heating rate of 10° C. per min, the polymer Tg was 85.4° C.

### Example 1

A 10 liter agitated vessel, equipped with a column and in-line condenser, was charged with 30 moles (4983 g) of terephthalic acid (Amoco TA-33-LP), 32.31 moles (2006.6 g) ethylene glycol, 2.19 moles (319.6 g) of isosorbide, 12.0 ml of GeO₂ solution (0.15 g Ge/ml), 0.797 ml tetramethylammonium hydroxide (25 wt % aq solution), 0.628 g cobalt acetate tetrahydrate, 0.089 g graphite (Timrex KS-4) and 2.975 g of Irganox® 1010 antioxidant. After 3 nitrogen pressure/purge cycles, the unit was pressured to 35 psig and the vessel heater setpoint was adjusted to give an initial batch temperature of 250° C. After approximately 90% of the water of reaction was removed, the vessel pressure was reduced to atmospheric pressure to continue esterification for 1 h. After 50 min into the atmospheric pressure esterification, a mixture containing 18.83 ml of a 3% solution of phosphoric acid in ethylene glycol and 2.975 g of Sandostab® P-EPQ was added to the vessel. The vessel was heated to 265° C. while the pressure was dropped to approximately 1 mm Hg over 30 min. After polymerizing 2 h at 1 mm Hg, the agitator was stopped and the vessel pressure was raised to approximately 50 psig. The melt was extruded under nitrogen pressure through a die plate to make a polymer strand. The strand was pulled through water troughs and into a cutter to make ⅛″ pellets. The product IV was 0.42 dL/g. Polymer color as measured by a HunterLab Colorflex was a*=−0.16, b*=−0.21 and L*=64.9. When measured by differential scanning calorimetry (DSC) at a heating rate of 10° C. per min, the polymer Tg was 85.3° C.

### Comparative Example 2

A 236 liter vessel, equipped with a helical agitator, column, condenser, melt pump and 6 hole die, was charged with 38 Kg of terephthalic acid (Amoco TA-33-LP), 15.29 Kg ethylene glycol, 2.437 Kg of isosorbide, 91.5 ml of GeO₂ solution (0.15 g Ge/ml), 7.26 g tetramethylammonium hydroxide (25 wt % aq solution), 4.79 g cobalt acetate tetrahydrate, and 0.68 g graphite (Timrex KS4). After 3 nitrogen pressure/purge cycles, the unit was pressured to 35 psig and the vessel heater set point was adjusted to give an initial batch temperature of 250° C. The vapor temperature at the top of the distillation column was controlled by injection of water to the top of the column. After approximately 90% of the water of reaction was removed, the vessel pressure was reduced to atmospheric pressure to continue esterification for 1 h. After 50 min into the atmospheric pressure esterification, 5.07g of phosphoric acid was added to the vessel. The vessel was heated to 265° C. while the pressure was dropped to approximately 1 mm Hg over 30 min. After polymerizing 237 min at approximately 1 mm Hg, the agitator torque at 20 rpm was 1800 in-lb and the melt temperature rose to 279° C. The agitator was stopped and the vessel was discharged at a melt pump pressure of 180 psig. The strands were pulled through water troughs and into a cutter to make ⅛″ pellets. The product IV was 0.57 dL/g. Polymer color as measured by a HunterLab Colorflex was: a*=−0.42, b*=1.85 and L*=49.8. When measured by differential scanning calorimetry (DSC) at a heating rate of 10° C. per min, the polymer Tg was 86.7° C. NMR analysis found 1.17% DEG and 3.16% isosorbide (87.0% of theoretical) in the polymer.

### Example 2

A 236 liter vessel, equipped with a helical agitator, column, condenser, melt pump and 6 hole die, was charged with 38 Kg of terephthalic acid (Amoco TA-33-LP), 15.29 Kg ethylene glycol, 2.437 Kg of isosorbide, 91.5 ml of GeO₂ solution (0.15 g Ge/ml), 7.26 g tetramethylammonium hydroxide (25 wt % aq solution), 4.79 g cobalt acetate tetrahydrate, 22.68 g of Irganox® 1010 antioxidant and 0.68 g graphite (Timrex KS4). After 3 nitrogen pressure/purge cycles, the unit was pressured to 35 psig and the vessel heater set point was adjusted to give an initial batch temperature of 250° C. The vapor temperature at the top of the distillation column was controlled by injection of water to the top of the column. After approximately 90% of the water of reaction was removed, the vessel pressure was reduced to atmospheric pressure to continue esterification for 1 h. After 50 min into the atmospheric pressure esterification, 5.07 g of phosphoric acid and 22.68 g of Sandostab® P-EPQ antioxidant were added to the vessel. The vessel was heated to 265° C. while the pressure was dropped to approximately 1 mm Hg over 30 min. After polymerizing 212 min at approximately 1 mm Hg, the agitator torque at 20 rpm was 1800 in-lb and the melt temperature rose to 273° C. The agitator was stopped and the vessel was discharged at a melt pump pressure of 180 psig. The strands were pulled through water troughs and into a cutter to make ⅛″ pellets. The product IV was 0.57 dL/g. Polymer color as measured by a HunterLab Colorflex was: a*=−0.46, b*=−0.20 and L*=49.0. When measured by differential scanning calorimetry (DSC) at a heating rate of 10° C. per min, the polymer Tg was 87.0° C. NMR analysis found 1.18% DEG and 3.17% isosorbide (87.2% of theoretical) in the polymer.

What is claimed is:

1. A melt polymerization process for the preparation of poly(ethylene-co-isosorbide) terephthalate (PEIT), comprising:
a) heating a mixture comprising terephthalic acid or its alkyl ester, ethylene glycol, isosorbide and a primary antioxidant in an inert atmosphere at a temperature of 180° C.-265° C. and a pressure of 0-60 psig, with concurrent removal of a distillate comprising water or volatile alkanol products derived from the reaction of terephthalic acid or its ester with ethylene glycol and isosorbide, wherein the molar ratio of diols to terephthalic acid or its alkyl ester is from about 1.05:1 to about 2.2:1, the molar ratio of ethylene glycol to isosorbide is from about 1.2:1 to about 24:1, and the amount of primary antioxidant is 50 to 1500 ppm by weight of the terephthalic acid or terephthalic alkyl ester charged and the distillate contains less than about 1 wt % ethylene glycol; and
b) further heating the mixture in the presence of a polycondensation catalyst and a secondary antioxidant, wherein the amount of the secondary antioxidant is 50 to 3000 ppm by weight based on the weight of the terephthalic acid or terephthalic ester charged, at a pressure of about 0.25 to about 2 mm and a temperature of 260° C. to 275° C. to form a PEIT having a Hunter b* color value between about −2.0 and about +2.0.

2. The process of claim 1, wherein the primary antioxidant is a hindered phenol.

3. The process of claim 1, wherein the secondary antioxidant is a trivalent phosphorus compound.

4. The process of claim 1, wherein the mixture of (a) comprises terephthalic acid, ethylene glycol, a primary antioxidant and isosorbide, and the distillate comprises water.

5. The process of claim 4, wherein the mixture further comprises a base selected from sodium acetate, sodium hydroxide and tetramethylammonium hydroxide, and the molar ratio of base to terephthalic acid is about 1:1,800 to 1:13,400.

6. The process of claim 1, wherein the mixture comprises dimethyl terephthalate, ethylene glycol, a primary antioxidant and isosorbide, and wherein the volatile alkanol product is methanol.

7. The process of claim 4 wherein the mixture further comprises a polycondensation catalyst selected from Sb(III) salts; Ti(IV) salts; acetate salts of Co(II); acetate salts of Sb(II); alkanoate salts of Co(II); alkanoate salts of Sb(III); oxides of Sb(III); oxides of Ge(IV); glycol-solubilized oxides of Sb(II), Sb(III) and Ge(IV); and Ti(OR)₄, where R is an alkyl group having 2 to 12 carbon atoms, and the molar ratio of catalyst to terephthalic acid or its alkyl ester is about 1:1000 to 1:7300.

8. The process of claim 7, wherein the polycondensation catalyst is a glycol-solubilized oxide of Ge(IV) or Sb(III).

9. The process of claim 4, wherein the temperature and pressure of the reaction are controlled in such a way that water is removed as a distillate only when the temperature of the overhead vapor is less than or equal to the boiling point of water at the pressure of the reaction.

10. the process of claim 4, wherein the mixture further comprises one or more additives selected from infrared absorbing agents, dyes, pigments, and UV stabilizers.

11. The process of claim 4, wherein one or more additives selected from infrared absorbing agents, dyes, pigments, and UV stabilizers is added to the mixture after removal of at least 80% of the water derived from the condensation of terephthalic acid with ethylene glycol and isosorbide.

12. The process of claim 10 or claim 1 1, wherein the dyes and pigments are selected from red, orange, yellow, blue, green, indigo and violet dyes and pigments.

13. The process of claim 1, wherein the isosorbide has a UV transmittance at 220 nm of at least 80% when measured in a 5 cm quartz cell as a 20 wt % aqueous solution.

14. The process of claim 1, further comprising:
a) isolating the PEIT polymer in the form of pellets, flakes or strands;
b) crystallizing the isolated PEIT polymer by heating the isolated PEIT polymer to a temperature in the range of about 125° C. to about 145° C. or treating the isolated PEIT polymer with a crystallization-inducing solvent; and
c) heating the crystallized PEIT polymer under vacuum or in a stream of inert gas at a temperature above about 190° C. but below the melting temperature of the crystallized PEIT polymer to yield a solid state polymerized PEIT polymer.

15. The process of claim 14, further comprising melt-mixing the solid state polymerized PEIT polymer with additives selected from the group consisting of infrared absorbing agents, dyes, pigments, and UV stabilizers.

16. The process of claim 1, wherein the molar ratio of ethylene glycol to isosorbide is from about 6:1 to about 18:1.

17. A PEIT polymer produced by the process of claim 1, claim 14 or claim 15, wherein the Hunter b* color of the PEIT polymer is between about −2.0 and about +2.0.

18. A shaped article comprising the PEIT polymer of claim 17.

19. The shaped article of claim 18, wherein the article is selected from rigid containers, films, sheets, fibers, and monofilament strands.

20. An optical article comprising the PEIT polymer of claim 17.

21. A polymer blend or alloy comprising the PEIT polymer of claim 17.
